(19) United States
(12) Patent Application Publication
(10) Pub. No.: US 2015/0210569 A1
(43) Pub. Date: Jul. 30, 2015

(54) DRINKING WATER VENDING DISPENSER FACILITATED TO COLLECT AND PURIFY DRAINAGE WATER

(71) Applicants: Amots Dgani, Kfar Saba (IL); Ido Grinberg, Hod Hasharon (IL); Itai Tais Zamir, Tel Aviv (IL); Ronen Berman, Matan (IL)

(72) Inventors: Amots Dgani, Kfar Saba (IL); Ido Grinberg, Kfar Saba (IL); Itai Tais Zamir, Tel Aviv (IL); Ronen Berman, Matan (IL)

(73) Assignee: WOOSH WATERSYSTEM LTD, Kfar Saba (IL)

(21) Appl. No.: 14/270,372

(22) PCT Filed: Jun. 21, 2012
(86) PCT No.: PCT/IL2012/000242

§ 371 Date: Mar. 27, 2015

(30) Foreign Application Priority Data
Jul. 10, 2011 (IL) 213998

(51) Int. Cl. C02F 1/78; B01D 15/08; B01D 29/01; B01D 61/08

(52) U.S. Cl. CPC C02F 1/78; B01D 61/08; B01D 15/08; B01D 29/01; C02F 2303/04; C02F 2307/10

(57) ABSTRACT

A drinking water vending dispenser for dispensing purified water comprising a coarse mechanical filter, an RO purification unit, an ozone purification unit, a UV purification unit, an active carbon filter, a chemical base purification unit and a fine mechanical filter.

### RELATED APPLICATIONS

This application claims priority of a PCT/IL2012/000242 filed on 21 Jun. 2012 which claimed priority of Israeli patent application number 213998 filed on 10 Jul. 2011.

### FIELD OF THE INVENTION

This invention relates in general to water purification systems and more particularly, the present invention relates to water purifying units, including in vending dispensers for dispensing drinking water that offer also a water vessel disinfection, with water enriched with ozone. The said drinking water vending dispenser machine recycles substantially all the waste water generated by the system. The system may also include any type of water inlets, be it clean or contaminated, and a series of water purifying units that purifies substantially all the incoming water.

### BACKGROUND OF THE INVENTION

Water quality is deteriorating all over the world, where pollution contaminates many natural water resources. According to updated data reviled in a recent “UN water report”, the world is on the verge of a water crisis. Currently, over 2 billion citizens around the world have no access to safe drinking water. As a result 80% of illness and death in underdeveloped countries is due to water contamination. The report has stated that managing drinking water is essential if the world is to achieve sustainable living.

Hence, safe drinking water is becoming a very valuable recourse, one that should be dealt with great care, especially when planning a water treatment system. Drinking water is a valuable resource, especially after a partial purification or complete purification stages have been applied on it. There are particle filters, activated carbon filters, ozone based purification, reverse osmosis (RO) based purification, Ultra Violet (UV) based purification, processing and others. Current art provides a variety of water purification methods each having drawbacks, such as partial purification, high cost and producing a large quantity of wasted gray water. Farther more, in developed countries there is a current trend of banning the usage of bottled water in plastic bottles. Major cities around the world have banned already bottled water in the public domains. For example, London has banned the usage of bottled water in the public domain on Jan. 1, 2010. As for this date it is illegal to sell plastic bottles containing water on the streets, shopping malls, schools etc. As a result of such laws, there is a great need for an alternative solution for drinking water in the public domain. The term “gray water” as used herein refers to waste water that are a product of one or a combination of the following sources: drain water as a result of the purification element of the system, water streaming out of a drinking water faucet, water streaming from the bottle disinfection procedure and drained, leaks within the tubing of the system and a result of system cleaning processes using back flush, to clean the filters and/or ion-exchange and adsorption systems. Currently, an individual wanting to drink water in public places such as on the street/school/mall etc, is presented with two main options:
a) Tap water from fountains (which people don't trust and can be even less safe than tap water):
   Not safe due to various possible water contaminations, such as bacteria, chemicals, etc.
b) A common solution for drinking water on the street is by consuming mineral water:
   Not safe due to various possible water contaminations, such as: Toxic chemicals like BPA, leached from plastic bottles. Bottled water is a habitat for microbes.
   Not Green: the bottled water industry is responsible for great damage to the environment. The bottled water industry produces an annual Carbon foot print of 25,000,000 tons, uses 170,000,000 barrels of oil and only 10%-14% of the bottles wind up being recycled. In addition, transporting and marketing these bottles creates an additional environmental damage. For example, 25% of the bottled water is flown around the world. That's a significant additional carbon print.
   Very expensive, substantially more expensive than tap water.

There is a growing global demand for saving energy and resources. In light of the global ecological condition, a quick reduction of pollution levels (carbon foot print) and an increase in water savings are urgently needed.

There is therefore a need for and it would be advantageous to have a system providing a sustainable, environmental-friendly, healthy and cost effective solution for consuming water in public spaces, a system that can help minimize ecological and health hazards as well. Water purification systems for public and household use are well known in the art, including patents that describe waste water circulation but to a limited extent in order to reduce the drainage flow. In addition the waste water recycling is targeted to drain water which water is a byproduct of the purification process. The circulation issue was addressed in U.S. Pat. Nos. 4,599,166 and 6,099,735 where water is circulated and treated with ozone in order to eliminate biological mater within suspended water vessel. U.S. Pat. No. 5,997,738 provides a RO system that recycles part of the RO drain water. U.S. Pat. No. 4,554,688 presents again similar idea for heating/cooling systems.

Patent CN200951965 Y where there is up to 100% waste water recycling. However there is no suggestion to eliminate the waste water completely in a drinking water vending and/or dispenser machine, waste water in a drinking water vending machine could be a product of one or a combination of the following sources: drain water as a result of the purification element of the system, water streaming out of a drinking water faucet, water streaming from the bottle disinfection procedure and drained, leaks within the tubing of the system and a result of system cleaning processes using back flush, to clean the filters and/or ion-exchange and Back flush, which is a reverse flow of the water in a system, in order to clean the system from accumulated contaminating elements, is described in USP application 20020008068 by Gary L. Anderson as a method for cleaning a fluid filter.

### SUMMARY OF THE INVENTION

By way of introduction, the principal intentions of the present invention include providing water purifying vending dispenser, designed to eliminate a substantial quantity of the drainage stream of the water purifying systems and the vending dispenser as a whole. The water purifying vending dispenser includes one or more purification units The patent is applicable when the inlet water stream is municipal drinking water, well water, gray water air conditioning condensate water or collected rain water. According to the teachings of the present invention there is provided a drinking water vending dispenser including a water inlet pipe, a drainage water container, water purifying subsystem, an optional water chiller, a purified water outlet, an optional cold purified water outlet, a controller, a payment subsystem and a user interface.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a schematic block diagram illustration of a drinking water vending dispenser, according to embodiments of the present invention;

FIG. 2 is a more detailed example schematic block diagram illustration of a drinking water vending dispenser, as in FIG. 1, and further including a back-flush mechanism;

FIG. 3 illustrates a water purification mini system of a water vending dispenser as in FIG. 2; and

FIG. 4 illustrates the control sub system of a water vending dispenser, as in FIGS. 1 and 2, communicating with an RFID bottle, according to variations of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art. Unless otherwise defined, all technical and scientific terms used herein have the same meaning as commonly understood by one of ordinary skill in the art to which this invention belongs. The methods and examples provided herein are illustrative only and not intended to be limiting.

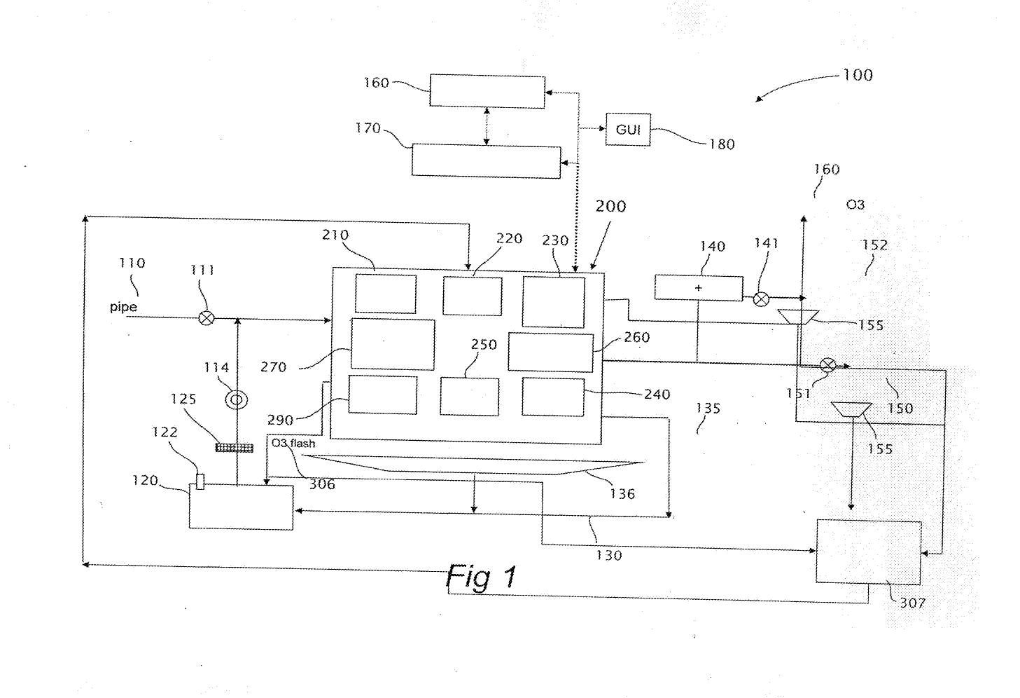

Reference is now made to the drawings. FIG. 1 is a schematic block diagram illustration of a drinking water vending dispenser 100, according to embodiments of the present invention. Drinking water vending dispenser 100 includes a water inlet pipe 110, a drainage water container 120, a water purifying subsystem 200, an optional water chiller 140, a purified water outlet 150, an optional cold purified water outlet 152, a controller 160, a payment subsystem 170 and a user interface 180.

Drinking water vending dispenser 100 may have a variety of input water sources serving as an input water stream fed into water purifying subsystem 200. The input water stream may include tap water from water inlet 110, well water, gray water from air conditioning condensate water or collected rain water, or any other source of gray water.

Water purifying subsystem 200 may include two or more water purification means. The water purifying subsystem 200 May include a coarse mechanical filter 210 for collecting particles, typically larger than 50 μm, a reverse osmosis (RO) system 220, an ozone purification unit 270, an active carbon filter 230, a fine mechanical filter 240 for collecting particles, typically larger than 1 μm, an UV purification unit 250, a chemical based purification unit 260 such as Chlorine based, purification unit 260 and other filters and purification units 290, for example de-ionizing devices, and others.

Many of the purification units perform processes in which one portion of the incoming water is purified and thereby producing purified water, and the other portion of the incoming water deteriorates and thereby producing drained water. Often, the drained water portion is substantially larger than the purified water portion. For example, in a typical RO purifying system, the ratio is 1:5. That is, 1/5 of the incoming water is purified water and 4/5 become drained water.

An aspect of the present invention is to recollect the drained water, which drained water are than re-entered into water purifying subsystem 200 to be re-processed. The drained water produced in the purifying unit 200 is collected directly by a purification waste water pine 135, which directs it to the main drainage water pipe 130. All drained water flows into the drainage water container 120, to be transferred at a later stage to water purifying subsystem 200, for reprocessing. Drained water 155 from the water streaming of the O3 sanitary flash outlet 160 (the vessel disinfection system) will not flow to the drainage water container 120 but, flows to the external drainage water container 307 and from their directly to the purifying subsystem 200.

The purified water portion is then streams through a purified water outlet 150 to be consumed. In variations of the present invention, the purified water portion is passed through a chiller 140 in order to provide cold drinking water through a cold purified water outlet 152.

Typically, water outlet 150 and 152 include a collecting sink 155 or any other drain water collecting mechanism. It is an aspect of the present invention to recollect the drained water from sinks 155, which drained water are then transferred to drainage water container 120 via the main drainage water pipe 130. Preferably, drinking water vending dispenser 100 further includes a sink 136 to collect water leaks, when such water leaks out of the system components occur. The collected water leaks are lead into drainage water container 120 via the main drainage water pipe 130.

In variations of the present invention, the drinking water vending dispenser, with a water purifying subsystem 200, includes a back flush mechanism. The back flush subsystem activates a reverse water current flow (“back flush”) to flash/wash one or more water purification units of water purifying subsystem 200.

The purifying and antibacterial properties of purifying system 200 may be used in order to clean and sanitize the tubular components of system 100. These purification systems may use an ozonized water unit, a Chlorine based unit or any other chemical used for bacterial treatment of water or any purifying unit that provides clean purified water.

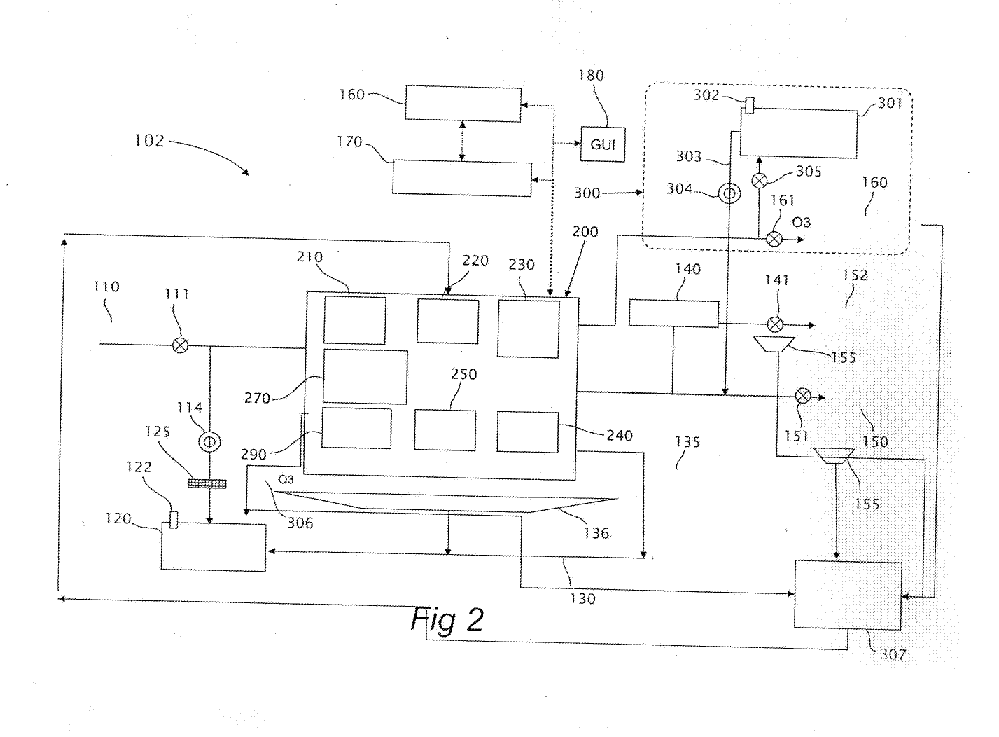

Reference is also made to FIG. 2, which is a more detailed example schematic block diagram illustration of a drinking water vending dispenser 102, according to variations of the present invention. Drinking water vending dispenser 102 includes a backflush subsystem 300 that streams a reverse current flow (“backflush”) into tubular components of system 102. Backflush subsystem 300 includes a sanitary water container 301 having a water level sensor 302, water pump 304 and an inlet sanitary pipe 303. Water level sensor 302, water pump 304 and the water valve 305 are operatively connected to controller 160.

When controller 160 activates the back flush mode, the normally closed water valve 305 is opened, water valve 161 is closed and purification subsystem 200 is turned on. Thereby, sanitary water container 301 is filled with sanitary water. When water level sensor 302 senses a predesigned high water level, control unit 160 shuts down the operation of purification unit subsystem 200, activates water pump 304, and closes inlet water valve 111. Thereby, a reverse current of sanitary water is steamed into designated purification units of purification unit subsystem 200, typically, into tubular components. When water level sensor 302 senses a predesigned low water level in sanitary water container 301, control unit 160 deactivates the back-flush mode, thereby system 102 returns to normal operation mode. All the back-flush water flows from purification unit subsystem 200 to drainage water container 120 via purification waste water pine 135.

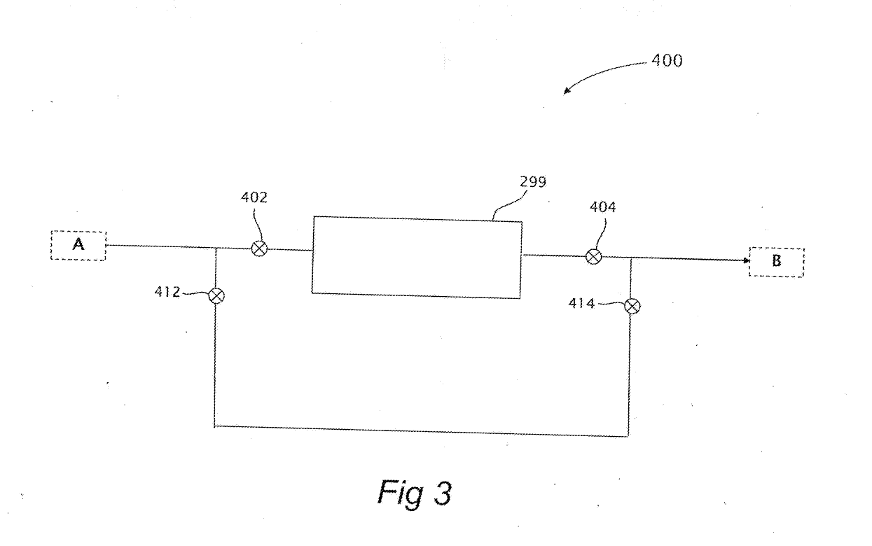

Reference is now also made to FIG. 3, which illustrates a water purification mini system 400 of water vending dispenser 102 having a back-flush subsystem (300). Water purification mini system 400 includes a water purifying unit 299, which unit 299 is sensitive to the back-flush process. To prevent any harm to unit 299. Therefore, water purification mini system 400 includes a bypass mechanism. The bypass mechanism includes valves 402, 404, 406 and 408.

When controller 160 sets water vending dispenser 102 to operate in normal mode, the inlet water flows from location A towards location B. The inlet water flows into the purification unit 299 via valve 402 and exits purification unit 299 via valve 404. Valves 406 and 408 remain closed. When controller 160 sets water vending dispenser 102 to operate in back flush mode, valves 402 and 404 are closed and valves 406 and 408 are opened. The water now flows from location B towards location A. Thereby, purifying unit 299 is not exposed to the back flush process. Valves 402, 404, 406 & 408, are operatively controlled by controller 160.

Generally, drainage water container 120 collects drained water from substantially all drained water generating members of drinking water vending dispenser 100. The collected water is then transferred at a later stage to water purifying subsystem 200, for reprocessing. It should be noted that gray water can be also transferred to drainage water container 120 from external sources such as air conditioning condensate water, collected rain water or any other source.

Drinking water vending dispenser 100 further includes a control unit 160, a payment subsystem 170 and a user interface 180, typically a graphical user interface (GUI). Control unit 160 controls substantially all operational aspects of drinking water vending dispenser 100. Drainage water container 120 includes water level sensor 122, which sensor senses the water level inside drainage water container 120. Water level sensor 122 is operatively connected to control unit 160. When water level sensor 122 senses a predesigned high water level, control unit 160 closes water inlet valve 111, activates water pump 114, thereby streaming gray water from drainage water container 120 to water purifying subsystem 200. Optionally, in order to protect pump 114 and reduce the impurities entered to the subsystem 200, one or more filters, such as a course mechanical filter 125, are disposed between drainage water container 120 and pump 114.

When water level sensor 122 senses a predesigned lower water level, control unit 160 deactivates water pump 114, opens tap water valve 111, thereby streaming the inlet water from water inlet 110 to water purifying subsystem 200.

After a user makes a payment via payment subsystem 170, control unit 160 opens either valve 151 or valve 141, thereby purified water is dispensed via purified water outlet 150 or cold purified water outlet 152, respectively.

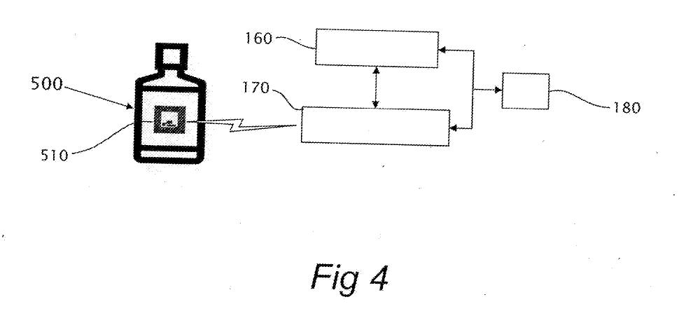

Reference is now also made to FIG. 4, which illustrates the control sub system of a water vending dispenser (100, 102), communicating with an RFID bottle 500, according to variations of the present invention. An aspect of the present invention is to provide a bottle 500 including an RFID tag 510, wherein RFID tag 510 can be read by payment sub-system 170, thereby control unit 160 can identify the owner of bottle 500 and thereby debiting the identified owner of bottle 500.

An aspect of the present invention is to provide a dispenser for dispensing a bottle 500, which bottle 500 includes an RFID tag 510, wherein RFID tag 510 can be read by the dispenser and by payment sub-system 170. The purchaser of bottle 500 can provide identity information and payment means information for future purchasing, wherein the dispenser can write the identity information and payment related information onto RFID tag 510 of bottle 500.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

In the FIGS: 110 is the water inlet pipe, 120 is the drainage water container, 135 is the purification waste water, 140 is the chiller and the thermostat, 152 is the cold purified water outlet, 160 is the controller, 160 is the 03 sanitary flash outlet, 170 is the payment sub system, 210 is the coarse filter, 220 is the RO, 230 is the active carbon filter, 240 is the fine filter, 250 is the UV unit, 260 is the chemical treatment, 270 is the ozone purification unit, 290 is the other filters and 307 is the bottle wash and water outlet drainage water container and 299 is the Water purifying unit.

What is claimed is:

1. A drinking water vending dispenser for dispensing purified water comprising a coarse mechanical filter, an RO purification unit, an ozone purification unit, a UV purification unit, an active carbon filter, a chemical base purification unit and a fine mechanical filter.

2. One or more aspects of the drinking water vending dispenser as in claim 1, substantially as described herein.

3. The drinking water vending dispenser for dispensing purified water machine as in claim 1 further comprising a tap water inlet and/or any type of water inlet, be it clean or contaminated.

4. One or more aspects of the drinking water vending dispenser as in claim 3, substantially as described herein.

5. The drinking water vending dispenser for dispensing purified water machine as in 3 further comprising, a complete waste water recycling system in a drinking water vending dispenser machine, waste water in a drinking water vending machine could be a product of one or a combination of the following sources: drain water as a result of the purification element of the system, water streaming out of a drinking water faucet, water streaming from the bottle disinfection procedure and drained, leaks within the tubing of the system and a result of system cleaning processes using back flush, to clean the filters and/or ion-exchange and adsorption system; The drinking water vending dispenser for dispensing purified water machine as in claims 1, further comprising a unique method to disinfect the drained water from the water faucet and from the bottle cleansing water stream; Water streaming from the faucet and bottle disinfection is exposed to external possible contamination hazards and so, need to be treated separately from the other drained water; Water streaming from the faucet and bottle disinfection flows directly to the vending machine purifying subsystem; In the purifying subsystem it flows through a RO and/or Ozone disinfection systems which are part of the purifying subsystem.

6. Back flush system with water enriched with ozone to better clean the filters and pipes of the vending machine.

7. Elimination of possible infection of water stored in water tank by ozone injection and water circulation in predefined time intervals

8. One or more aspects of the drinking water vending dispenser as in claim 1, substantially as described herein.
